(19) United States
(12) Patent Application Publication
(10) Pub. No.: US 2021/0318126 A1
(43) Pub. Date: Oct. 14, 2021

(54) DRIVER ASSISTANCE APPARATUS AND METHOD OF THEREOF

(71) Applicant: MANDO CORPORATION, Pyeongtaek-si (KR)

(72) Inventor: Kyusik PARK, Bucheon-si (KR)

(21) Appl. No.: 17/225,561

(22) Filed: Apr. 8, 2021

(30) Foreign Application Priority Data
Apr. 13, 2020 (KR) 10-2020-0044522

(51) Int. Cl. G01C 21/34; G01C 21/00; B60W 30/095; B60W 30/09; B60W 30/06; B60W 10/04; B60W 10/18; B60W 10/20; G01C 21/36; B60W 10/10; B60W 60/00

(52) U.S. Cl. CPC G01C 21/3407; G01C 21/3889; B60W 30/0956; B60W 30/09; B60W 30/06; B60W 60/001; B60W 10/18; B60W 10/20; G01C 21/3661; B60W 10/10; B60W 10/04

(57) ABSTRACT

A driver assistance apparatus according to the disclosed embodiment receives building map information, determines whether a parking space exists from the building map information, and generates a travel route to the parking space based on the existence of the parking space, and a controller is configured to detect a front object located in front of the vehicle and a side object located on the side of the vehicle in response to processing the image data, the front detection data, and the side detection data, and output a signal to at least one of a driving device, a braking device, and a steering device of the vehicle to travel the travel route based on a detected result.

### CROSS-REFERENCE TO RELATED APPLICATION

This application is based on and claims priority under 35 U.S.C. § 119 to Korean Patent Application No. 2020-0044522, filed on Apr. 13, 2020 in the Korean Intellectual Property Office, the disclosure of which is incorporated herein by reference.

### BACKGROUND

### 1. Field

The present disclosure relates to a driver assistance apparatus, a driver assistance method, and a driver assistance system.

In more detail, the present disclosure relates to setting a travel route so that the vehicle may autonomously drive to the parking space, and controlling a plurality of devices provided in the vehicle to enable autonomous parking when the vehicle arrives in a parking space.

### 2. Description of the Related Art

In the conventional autonomous parking method, a user directly drives a vehicle to a parking space, and autonomous parking is performed when the user arrives at the parking space.

However, the conventional autonomous parking method has a problem in that the user must directly find a parking space due to the absence of building information, and a problem that autonomous parking is also impossible when there is no parking space.

### SUMMARY

In order to solve the above-described problem, it is an object of the disclosure to provide a driver assistance apparatus capable of searching for a parking space and generating a travel route to the parking space, a driver assistance method, and a driver assistance system.

It is another object of the disclosure to provide a driver assistance apparatus capable of autonomously driving a vehicle to a parking space and performing autonomous parking when a vehicle arrives at the parking space, a driver assistance method, and a driver assistance system.

It is an aspect of the disclosure to provide a driver assistance apparatus including: a sensor installed in a vehicle and acquiring at least one of front image data, front detection data, and side detection data; and a controller including a processor configured to process the front image data, the front detection data, and the side detection data, wherein the controller is configured to receive building map information, determine whether a parking space exists from the building map information, and generate a travel route to the parking space based on the presence or absence of the parking space, and wherein the controller is configured to detect a front object located in front of the vehicle and a side object located on the side of the vehicle in response to processing the image data, the front detection data, and the side detection data, and output a signal to at least one of a driving device, a braking device, and a steering device of the vehicle to travel the travel route based on a detected result.

When the vehicle reaches the parking space, the controller may output a signal to at least one of an engine, a braking device, and a steering device of the vehicle to perform automatic parking.

The controller may determine whether the parking space exists, and perform double parking based on a determined result.

The controller may set the gear of the vehicle to neutral when it is determined that the vehicle is double-parked.

The controller may detect a movement of another vehicle and change the travel route to avoid travelling the other vehicle.

The controller may transmit information on the travel route to a user terminal.

The controller may transmit the result of the automatic parking to the user terminal.

It is an aspect of the disclosure to provide a driver assistance method including: acquiring at least one of front image data, front detection data, and side detection data; processing the front image data, the front detection data, and the side detection data; receiving building map information, determining whether a parking space exists from the building map information, and generating a travel route to the parking space based on the existence of the parking space; and detecting a front object located in front of the vehicle and a side object located on the side of the vehicle in response to processing the image data, the front detection data, and the side detection data, and outputting a signal to at least one of a driving device, a braking device, or a steering device of the vehicle to travel the travel route based on a detected result.

When the vehicle reaches the parking space, the driver assistance method may further include outputting a signal to at least one of an engine, a braking device, and a steering device of the vehicle to perform automatic parking when the vehicle reaches the parking space.

The driver assistance method may further include determining whether the parking space exists, and performing double parking based on the determined result.

The driver assistance method may further include setting a gear of the vehicle to neutral when it is determined that the vehicle is double-parked.

The driver assistance method may further include detecting a movement of another vehicle and changing the travel route to avoid travelling the other vehicle.

The driver assistance method may further include transmitting information on the travel route to a user terminal.

The driver assistance method may further include transmitting the result of the automatic parking to a user terminal.

It is an aspect of the disclosure to provide a driver assistance system including: a sensor installed in a vehicle and acquiring at least one of front image data, front detection data, and side detection data; and a controller including a processor configured to process the front image data, the front detection data, and the side detection data, wherein the controller is configured to receive building map information, determine whether a parking space exists from the building map information, and generate a travel route to the parking space based on the presence or absence of the parking space, and wherein the controller is configured to detect a front object located in front of the vehicle and a side object located on the side of the vehicle in response to processing the image data, the front detection data, and the side detection data, and output a signal to at least one of a driving device, a braking device, and a steering device of the vehicle to travel the travel route based on a detected result.

The controller may output a signal to at least one of an engine, a braking device, and a steering device of the vehicle to perform automatic parking when the vehicle reaches the parking space.

The controller may determine whether the parking space exists, and perform double parking based on the determination result.

The controller may set the gear of the vehicle to neutral when it is determined that the vehicle is double parking.

The controller may detect a movement of another vehicle and change the travel route to avoid travelling the other vehicle.

The controller may transmit at least one of the travel route or the automatic parking result to the user terminal.

The driver assistance apparatus, the driver assistance method, and the driver assistance system including the above-described configuration expand the existing autonomous parking system, thereby increasing the user's parking convenience.

In addition, the disclosed embodiment has an effect of acquiring information on a parking space in advance by utilizing the building information, and preventing unnecessary fuel consumption used for driving to find a parking space.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a configuration of a vehicle according to an embodiment.

FIG. 2 is a diagram illustrating a configuration of a driver assistance system according to an embodiment.

FIG. 3 is a diagram illustrating a camera and a radar included in a driver assistance system according to an embodiment.

FIG. 4 is a conceptual diagram of a driver assistance apparatus receiving building information according to an embodiment.

FIG. 5 is a control block diagram of a driver assistance apparatus according to an embodiment.

FIG. 6 is a flowchart illustrating a process of controlling a vehicle so that a controller may autonomously drive to a parking space according to an embodiment.

FIG. 7 is a flowchart illustrating a process of controlling a vehicle such that a controller performs double parking according to an embodiment.

FIG. 8A illustrates the display of building information on a user terminal according to an embodiment.

FIG. 8B is a diagram showing an indication of whether or not to consent to double parking on a user terminal according to an embodiment.

FIG. 8C illustrates displaying a parking result on a user terminal according to an embodiment.

### DETAILED DESCRIPTION

Like numerals refer to like factors throughout the specification. Not all factors of embodiments of the present invention will be described, and description of what are commonly known in the art or what overlap each other in the embodiments will be omitted.

The terms as used throughout the specification, such as “˜ part”, “˜ module”, “˜ member”, “˜ block”, etc., may be implemented in software or hardware, and a plurality of “˜ parts”, “˜ modules”, “˜ members”, or “˜ blocks” may be implemented in a single factor, or a single “˜ part”, “˜ module”, “˜ member”, or “˜ block” may include a plurality of factors.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, factors, and/or components, but do not preclude the presence or addition of one or more other features, integers, steps, operations, factors, components, and/or groups thereof, unless the context clearly indicates otherwise.

In the specification, it should be understood that, when a member is referred to as being “on/under” another member, it can be directly on/under the other member, or one or more intervening members may also be present.

The terms including ordinal numbers like “first” and “second” may be used to explain various components, but the components are not limited by the terms. The terms are only for distinguishing a component from another.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present invention will be described with reference to the accompanying drawings.

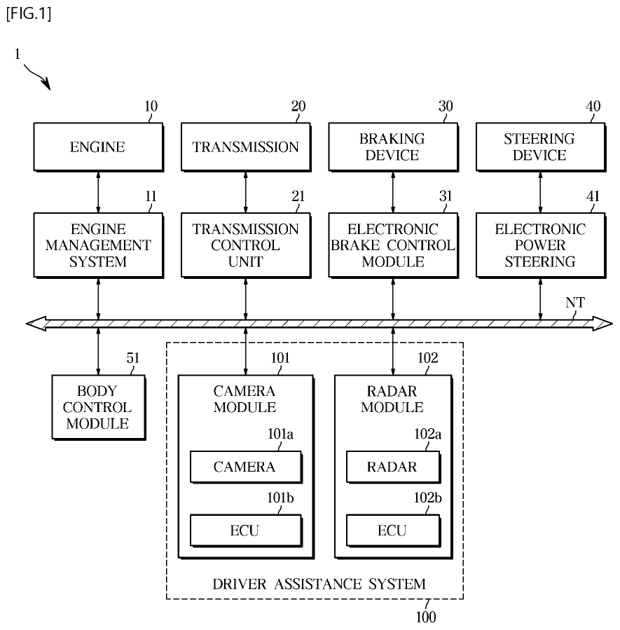

FIG. 1 illustrates a configuration of a vehicle according to an embodiment.

As shown in FIG. 1, the vehicle 1 includes an engine 10, a transmission 20, a braking device 30, and a steering device 40. The engine 10 may include a cylinder and a piston, and generate power for the vehicle 1 to travel. The transmission 20 may include a plurality of gears and transmit power generated by the engine 10 to wheels. The braking device 30 may decelerate the vehicle 1 or stop the vehicle 1 through friction with the wheels. The steering device 40 may change the travelling direction of the vehicle 1.

The vehicle 1 may include a plurality of electrical components. For example, the vehicle 1 further includes an engine management system (EMS) 11, a transmission control unit (TCU) 21, and an electronic brake control module (EBCM) 31), an electronic power steering (EPS) 41, a body control module (BCM), and a driver assistance system (DAS).

The EMS 11 may control the engine 10 in response to acceleration intent of a driver through an accelerator pedal or a request of a driver assistance apparatus 100. For example, the EMS 11 may control the torque of the engine 10.

The TCU 21 may control the transmission 20 in response to a shift command of the driver through a shift lever and/or a travelling velocity of the vehicle 1. For example, the TCU 21 may adjust the gear ratio from the engine 10 to the vehicle wheels.

The EBCM 31 may control the braking device 30 in response to a braking intent of a driver through a braking pedal and/or a slip of the vehicle wheels. For example, the EBCM 31 may temporarily release the braking of the vehicle wheel in response to a slip of the vehicle wheel sensed at a time of braking of the vehicle 1 (anti-lock braking systems, ABS).

The EBCM 31 may selectively release braking of the vehicle wheel in response to over-steering and/or under-steering sensed at a time of steering of the vehicle 1 (electronic stability control, ESC). In addition, the EBCM 31 may temporarily brake the vehicle wheels in response to a slip of the vehicle wheel sensed at a time of travelling of the vehicle 1 (traction control system, TCS).

The EPS 41 may assist the operation of the steering device 40 so that the driver easily manipulates the steering wheel, in response to a steering intent of the driver through the steering wheel. For example, the EPS 41 may assist the operation of the steering device 40 such that the steering force is reduced during low-velocity traveling or parking and is increased during high-velocity traveling.

The BCM 51 may control the operation of the electronic components that provide convenience to the driver or ensure the safety of the driver. For example, the BCM 51 may control a head lamp, a wiper, a cluster, a multifunction switch, a turn signal lamp, and the like.

The driver assistance apparatus 100 or the DAS may assist the driver in manipulating (driving, braking, steering) the vehicle 1. For example, the DAS 100 may detect a surrounding environment (e.g., another vehicle, a pedestrian, a cyclist, a lane, a road sign, etc.) around the vehicle 1 and control the driving and/or braking and/or steering of the vehicle 1 in response to the sensed surrounding environment.

The driver assistance apparatus 100 or the DAS may provide the driver with various functions. For example, the DAS 60 may provide a lane departure warning (LDW), a lane keeping assist (LKA), a high beam assist (HBA), an autonomous emergency braking (AEB), a traffic sign recognition (TSR), a smart cruise control (SCC), a blind spot detection (BSD), and the like.

The driver assistance apparatus 100 or the DAS may include a camera module 101 for acquiring image data around the vehicle 1 and a radar module 102 for acquiring object data around the vehicle 1. The camera module 101 may include a camera 101a and an electronic control unit (ECU) 101b, and may photograph the front of the vehicle 1 and recognize other vehicles, pedestrians, cyclists, lanes, road signs, and the like. The radar module 102 may include a radar 102a and an electronic control unit (ECU) 102b and may acquire relative positions and relative velocities of objects (e.g., other vehicles, pedestrians, cyclists, and the like) around the vehicle 1.

The driver assistance apparatus 100 or the DAS is not limited to that shown in FIG. 1, and may further include a lidar for scanning around the vehicle 1 and detecting an object.

The above described electronic components may communicate with each other through vehicle communication network (NT). For example, the electrical components may exchange data there between through Ethernet, media oriented systems transport (MOST), Flexray, controller area network (CAN), local interconnect network (LIN), and the like. For example, the driver assistance apparatus 100 may transmit a driving control signal, a braking signal, and a steering signal to the EMS 11, the EBCM 31, and the EPS 41, respectively, through the NT.

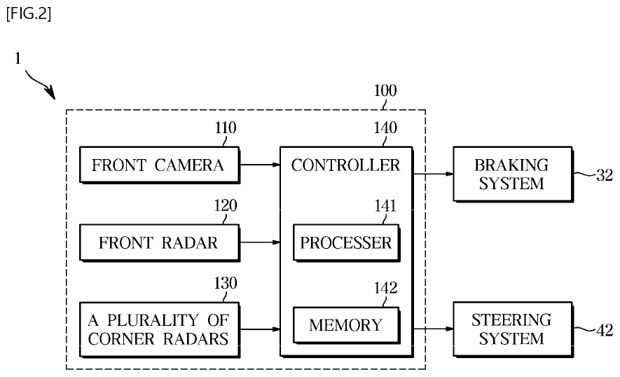

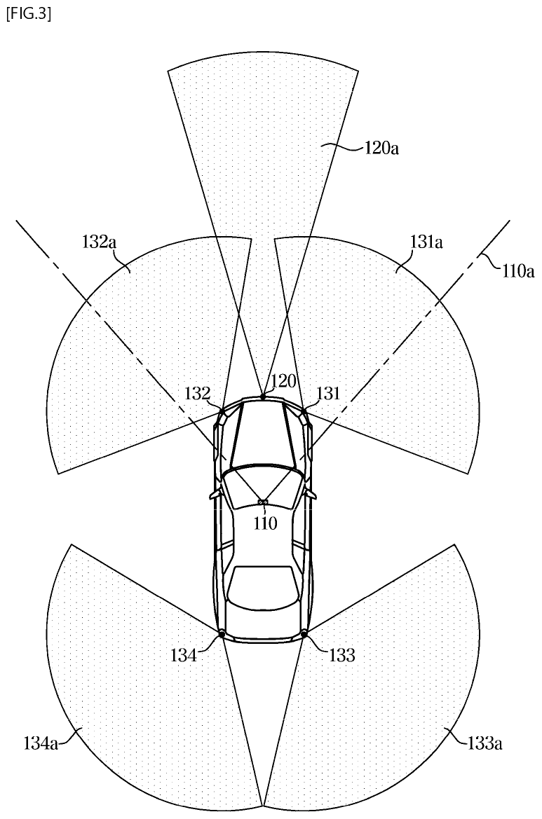

FIG. 2 is a diagram illustrating a configuration of the DAS according to an embodiment. FIG. 3 is a diagram illustrating a camera and a radar included in the DAS according to an embodiment.

As shown in FIG. 2, the vehicle 1 may include a braking system 32, a steering system 42, and a driver assistance apparatus 100 or a DAS.

The braking system 32 according to the embodiment may include the EBCM (31 in FIG. 1) and the braking device (30 in FIG. 1) described in conjunction with FIG. 1, and the steering system 42 may include the EPS (41 in FIG. 1) and the steering device (40 in FIG. 1).

The driver assistance apparatus 100 or the DAS may include a camera 110, a front radar 120, and a plurality of corner radars 130.

The camera 110 may have a field of view 110a directed to the front of the vehicle 1 as shown in FIG. 3. The camera 110 may be installed, for example, on the front windshield of the vehicle 1.

The camera 110 may image the front of the vehicle 1 and acquire image data regarding the front of the vehicle 1. The image data regarding the front of the vehicle 1 may include a position of another vehicle or a pedestrian or a cyclist or a lane located in front of the vehicle 1.

The camera 110 may include a plurality of lenses and an image sensor. The image sensor may include a plurality of photodiodes for converting light into electrical signals, and the plurality of photodiodes may be arranged in a two-dimensional matrix.

The camera 110 may be electrically connected to a controller 140. For example, the camera 110 may be connected to the controller 140 through a vehicle communication network NT, through a hard wire, or through a printed circuit board (PCB).

The camera 110 may transmit the image data of the front of the vehicle 1 to the controller 140.

The front radar 120 may have a field of sensing 120a directed to the front of the vehicle 1, as shown in FIG. 3. The front radar 120 may be installed, for example, on a grille or a bumper of the vehicle 1.

The front radar 120 may include a transmission antenna (or a transmission antenna array) that radiates transmission radio waves to the front of the vehicle 1 and a reception antenna (or a reception antenna array) that receives reflection radio waves reflected from an object. The front radar 120 may acquire front radar data from the transmission radio waves transmitted by the transmission antenna and the reflection radio waves received by the reception antenna. The front radar data may include position information and velocity information regarding an object, such as another vehicle, a pedestrian, or a cyclist existing in front of the vehicle 1.

The front radar 120 may calculate the relative distance to the object based on the phase difference (or time difference) between the transmission radio waves and the reflection radio waves, and calculate the relative velocity of the object based on the frequency difference between the transmission radio waves and the reflected radio waves.

The front radar 120 may be connected to the controller 140 through a vehicle communication network NT, a hard wire, or a printed circuit board. The front radar 120 may transmit the front radar data to the controller 140.

The plurality of corner radars 130 includes a first corner radar 131 installed on the front right side of the vehicle 1, a second corner radar 132 installed on the front left side of the vehicle 1, a third corner radar 133 installed on the rear right side of the vehicle 1, and a fourth corner radar 134 installed on the rear left side of the vehicle 1.

The first corner radar 131 may have a field of sensing 131a directed to the front right side of the vehicle 1, as shown in FIG. 3. The first corner radar 131 may be installed, for example, on the right side of a front bumper of the vehicle 1. The second corner radar 132 may have a field of sensing 132a directed to the front left side of the vehicle 1, and may be installed, for example, on the left side of the front bumper of the vehicle 1. The third corner radar 133 may have a field of sensing 133a directed to the rear right side of the vehicle 1 and may be installed, for example, on the right side of a rear bumper of the vehicle 1. The fourth corner radar 134 may have a field of sensing 134a directed to the rear left side of the vehicle 1 and may be installed, for example, on the left side of the rear bumper of the vehicle 1.

Each of the first, second, third and fourth corner radars 131, 132, 133, and 134 may include a transmission antenna and a reception antenna. The first, second, third, and fourth corner radars 131, 132, 133 and 134 acquire first corner radar data, second corner radar data, third corner radar data, and fourth corner radar data, respectively. The first corner radar data may include distance information and velocity information regarding another vehicle, a pedestrian or a cyclist (hereinafter, referred to as “an object”) existing on the front right side of the vehicle 1. The second corner radar data may include distance information and velocity information regarding an object existing on the front left side of the vehicle 1. The third and fourth corner radar data may respectively include distance and velocity information regarding an object existing on the rear right side of the vehicle 1 and distance and velocity information regarding an object located on the rear left side of the vehicle 1, respectively.

Each of the first, second, third, and fourth corner radars 131, 132, 133 and 134 may be connected to the controller 140, for example, through a vehicle communication network NT, a hard wire, or a printed circuit board. The first, second, third, and fourth corner radars 131, 132, 133, and 134 may respectively transmit the first corner radar data, the second corner radar data, the third corner radar data, and the fourth corner radar data to the controller 140.

The controller 140 may include the ECU (101b in FIG. 1) of the camera module (101 in FIG. 1) and/or the ECU (102b in FIG. 1) of the radar module (102 in FIG. 1), and/or an integrated ECU.

The controller 140 includes a processor 141 and a memory 142.

The processor 141 may process the front image data of the camera 110, the front radar data of the front radar 120, and the corner radar data of the plurality of corner radars 130, and generate a braking signal and a steering signal for controlling the braking system 32 and the steering system 42. For example, the processor 141 may include an image signal processor for processing the front image data of the camera 110 and/or a digital signal processor for processing radar data of the radars 120 and 130 and/or a micro control unit (MCU) for generating a braking signal and/or a steering signal.

The processor 141 may detect objects (e.g., another vehicle, a pedestrian, a cyclist, and the like) in front of the vehicle 1 based on the front image data of the camera 110 and the front radar data of the radar 120.

In detail, the processor 141 may acquire position information (distance and direction) and velocity information (relative velocity) of the objects in front of the vehicle 1 based on the front radar data of the front radar 120. The processor 141 may acquire position information (direction) and type information (for example, whether the object is another vehicle, a pedestrian or a cyclist) of the object existing in front of the vehicle 1 based on the front image data of the camera 110. In addition, the processor 141 may match the objects detected by the front image data with the objects detected by the front radar data, and acquire the type information, the position information, and the velocity information of the objects in front of the vehicle 1 based on a result of the matching.

The processor 141 may generate a braking signal and a steering signal based on the type information, the position information, and the velocity information of the front objects.

For example, the processor 141 calculates a time to collision (TTC) between the vehicle 1 and the front object based on the position information (relative distance) and the velocity information (relative velocity) of the front objects, and warns the driver of a collision, transmits a braking signal to the braking system 32, or transmits a steering signal to the steering system 42 based on a result of comparing the TTC with a predetermined reference time. In response to the TTC less than a predetermined first reference time, the processor 141 may allow an alert to be output via audio and/or display. In response to the TTC less than a predetermined second reference time, the processor 141 may transmit a preliminary-braking signal to the braking system 32. In response to the TTC less than a predetermined third reference time, the processor 141 may transmit an emergency braking signal to the braking system 32. In this case, the second reference time is shorter than the first reference time, and the third reference time is shorter than the second reference time.

As another example, the processor 141 may calculate a distance to collision (DTC) based on the velocity information (e.g., relative velocity) of front objects, and warn the driver of a collision or transmit a braking signal to the braking system 32 based on a result of comparing the DTC with distances to the front objects.

The processor 141 may acquire position (distance and direction) and relative velocity of the objects on the sides of the vehicle 1 (front right, front left, rear right, and rear left) based on corner radar data of the plurality of corner radars 130.

The processor 141 may transmit a steering signal to the steering system 42 based on the location (distance and direction) and relative velocity of side objects of the vehicle 1.

For example, when a collision with a front object is determined based on the TTC or the DTC, the processor 141 may transmit a steering signal to the steering system 42 to avoid collision with the front object.

The processor 141 may determine whether to avoid a collision with a front object by changing the driving direction of the vehicle 1 based on the position (distance and direction) and the relative speed of the side objects of the vehicle 1. For example, when there is no object located in the sides of the vehicle 1, the processor 141 may transmit a steering signal to the steering system 42 in order to avoid a collision with a front object. When the collision with the side object is not predicted after the steering of the vehicle 1 based on the position (distance and direction) and the relative speed of the side objects, the processor 141 may transmit a steering signal to the steering system 42 in order to avoid a collision with a front object. When the collision with the side object is predicted after the steering of the vehicle 1 based on the position (distance and direction) and the relative speed of the side objects, the processor 141 may not transmit the steering signal to the steering system 42.

The memory 142 may store programs and/or data for processing image data by the processor 141, programs and/or data for processing radar data by the processor 141, and programs and/or data for generating a braking signal and/or a steering signal by the processor 141.

The memory 142 may temporarily memorize the image data received from the camera 110 and/or the radar data received from the radars 120 and 130, and may temporarily memorize a result of processing the image data and/or the radar data of the processor 141.

The memory 142 may not only include a volatile memory, such as an S-RAM, a D-RAM, and the like, but also include a non-volatile memory, such as a flash memory, a read only memory (ROM), an erasable programmable read only memory (EPROM), and the like.

The driver assistance device 100 or the DAS is not limited to that shown in FIG. 2, and may further include a lidar for scanning around the vehicle 1 and detecting objects.

As such, the controller 140 may transmit a braking signal to the braking system 32 based on whether a collision with a front object is predicted.

When the side object does not exist or the collision with the side object is not predicted, the controller 140 may transmit a steering signal to the steering system 42 in order to avoid a collision with the front object.

When a collision with a side object is predicted after steering, the controller 140 may not transmit a steering signal to the steering system 42.

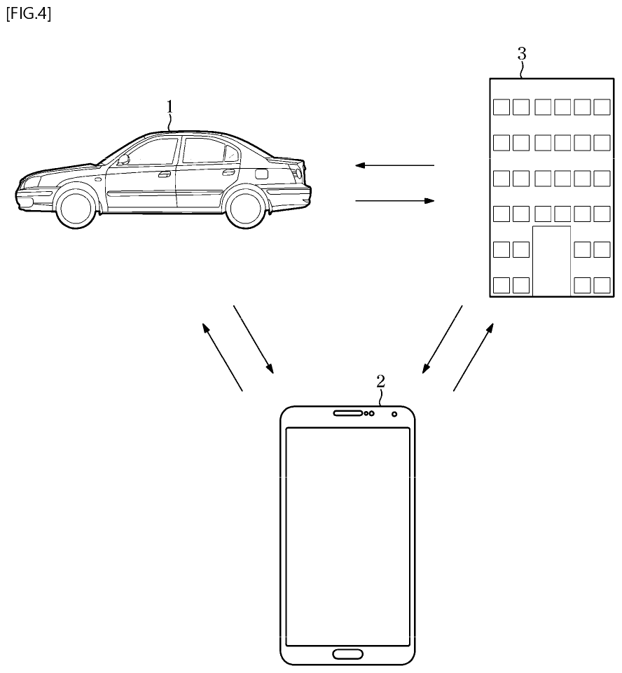

FIG. 4 is a conceptual diagram of the driver assistance apparatus 100 receiving building information according to an embodiment.

Referring FIG. 4, the driver assistance apparatus 100 provided in the vehicle 1 may communicate with a building 3 or a server provided in the building 3 and obtain information on a parking space. In addition, the driver assistance apparatus 100, the building 3, or the server provided in the building 3 may communicate information about the parking space in the building with the user terminal 2.

Here, the information on the parking space in the building may include the number of parkable parking lots, whether or not there is a parking lot for the disabled, whether an electric vehicle charging station exists or whether a hybrid vehicle charging station exists, whether an underground parking lot exists, whether a ground parking lot exists, a parking fee, or whether double parking may be performed, but is not limited thereto.

In addition, the user terminal 2 may be a smartphone, a display (not shown) provided in the vehicle 1, a navigation system, or an audio, video, navigation (AVN), but is not limited thereto.

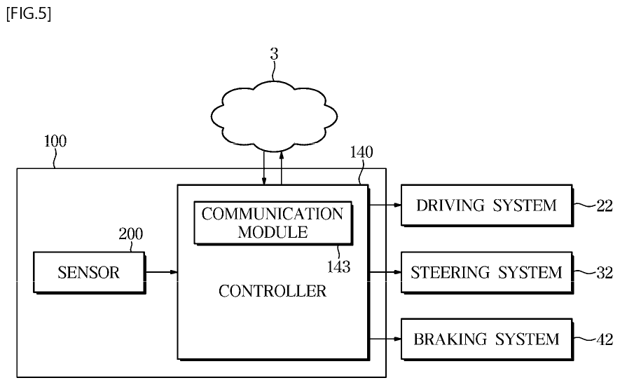

FIG. 5 is a control block diagram of the driver assistance apparatus 100 according to an embodiment.

Referring FIG. 5, the driver assistance apparatus 100 may include the controller 140 including a sensor 200 and a communication module 143, and the controller 140 may control the driving system 22, the braking system 32, or the steering system 42 provided in the vehicle 1. Further, the communication module 143 provided in the controller 140 may communicate with the building 3 or the server provided in the building.

Specifically, the sensor 200 may include a camera 110 for imaging the surroundings of the vehicle 1, and may include a lidar sensor or a radar sensor, and may acquire at least one of front image data, front detection data, and side detection data.

In addition, the controller 140 may include a processor for processing front image data, front detection data, or side detection data, receive the building map information, determine whether a parking space exists from the building map information, and generate a travel route to the parking space based on the existence of the parking space.

In addition, the controller 140 may generate a signal to a driving device included in the driving system 22, a steering device included in the steering system 32, or a braking device included in the braking system 42 so that the vehicle 1 autonomously drives the route created to the parking space.

Here, the driving device may include the engine 10 or the transmission 20, but is not limited thereto.

In addition, the controller 140, when the vehicle 1 reaches the parking space, may control the driving device included in the driving system 22 for performing automatic parking, the steering device included in the steering system 32, or the braking device included in the braking system 42

Here, automatic parking may include double parking.

Specifically, when it is determined that there is no parking space, the controller 140 may secondarily search for a place where double parking is possible and perform double parking. Double parking means that the vehicle 1 is not parked in a designated parking lot, but parallel parking in front of another vehicle that is already parked.

In addition, the controller 140 may transmit a message to the user terminal informing the user whether or not to allow double parking, and may receive a user's input signal from the user terminal.

In addition, when double parking is performed, the controller 140 may set the gear of the vehicle 1 to neutral (N).

In addition, the controller 140 may detect the movement of another vehicle or a surrounding object based on the detection result of the sensor 200, change the travel route to avoid driving other vehicles or surrounding objects, and transmit information on an existing travel route or a changed travel route to the user terminal.

In addition, when the automatic parking is completed, the controller 140 may transmit the automatic parking result to the user terminal.

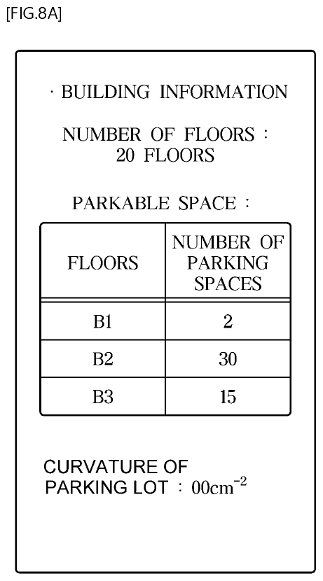

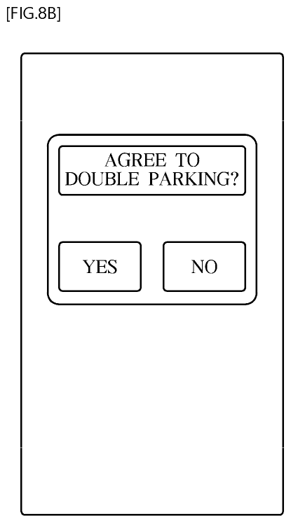

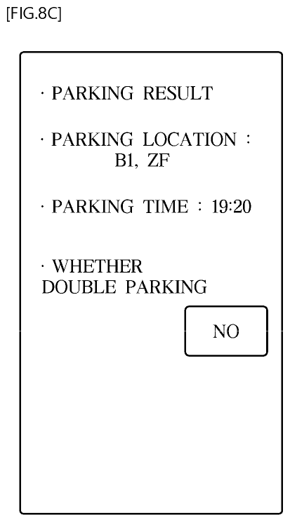

Displaying the parking process and the parking result on the user terminal will be described in detail with reference to FIG. 8.

In addition, the controller 140 may include a communication module 143 and may communicate with the building 3 or the server provided in the building 3.

Here, the communication module 143 may include one or more components enabling communication with an external device, and may include, for example, at least one of a short-range communication module, a wired communication module, and a wireless communication module.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, an NFC communication module, and a Zigbee communication module.

The wired communication modules may include not only various wired communication modules such as controller area network (CAN) communication modules, local area network (LAN) modules, wide area network (WAN) modules, or value added network (VAN) modules and the like, but also various cable communication modules such as universal serial bus (USB), high definition multimedia interface (HDMI), digital visual interface (DVI), recommended standard232 (RS-232), power line communication, or plain old telephone service (POTS) and the like

The wireless communication module may include a wireless communication module supporting various wireless communication methods such as global system for mobile communication (GSM), code division multiple access (CDMA), wideband code division multiple access (WCDMA), universal mobile telecommunications system (UMTS), time division multiple access (TDMA), long term evolution (LTE), in addition to the Wifi module and the Wireless broadband module.

The wireless communication module may include a wireless communication interface including an antenna and a transmitter for transmitting signals. In addition, the wireless communication module may further include a signal conversion module for modulating a digital control signal output from the controller into an analog type wireless signal through a wireless communication interface according to control of the controller.

The wireless communication module may include a wireless communication interface including an antenna and a receiver for receiving signals. In addition, the wireless communication module may further include a signal conversion module for demodulating an analog wireless signal received through the wireless communication interface into a digital control signal.

At least one component may be added or deleted according to the performance of the components of the driver assistance apparatus 100 illustrated in FIG. 5. In addition, it will be readily understood by those skilled in the art that the mutual positions of the components may be changed in response to the performance or structure of the system.

Meanwhile, each component illustrated in FIG. 5 refers to software and/or hardware components such as field programmable gate array (FPGA) and application specific integrated circuit (ASIC).

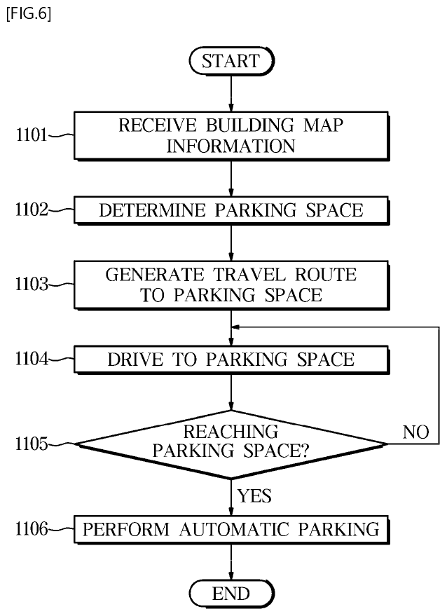

FIG. 6 is a flowchart illustrating a process of controlling the vehicle 1 so that the controller 140 may autonomously drive to a parking space according to an embodiment.

The communication module 143 provided in the controller 140 receives a building map from the building 3 or a server provided in the building 3 (1101).

Here, the building map may be a high definition map, but is not limited thereto.

In addition, the travel route may be the safest route, the shortest route, or the shortest time route according to user definition, but is not limited thereto.

The building map contains information on parking spaces.

As described above, the information on the parking space may include the number of parkable parking lots, whether or not there is a parking lot for the disabled, whether an electric vehicle charging station exists or whether a hybrid vehicle charging station exists, whether an underground parking lot exists, whether a ground parking lot exists, a parking fee, or whether double parking may be performed, but is not limited thereto.

When the building map is received, the controller 140 determines and determines the parking space (1102).

Specifically, the controller 140 may set the priority of the parking space according to the user definition, and may determine the parking space based on the set priority.

For example, the priority of the parking space set by the user is a safest parking space, a parking space in the shortest route, a parking space in the shortest time route, a parking space located at the shortest distance from the destination or building entrance, or a parking space located at the shortest distance from the elevator, but is not limited thereto.

When the parking space is identified and determined, the controller 140 generates a travel route to the parking space (1103). Specifically, the travel route may be the safest route, the shortest route, or the shortest time route according to user definition, but is not limited thereto.

When a travel route is generated, the controller 140 controls at least one of a driving device, a steering device, and a braking device so that the vehicle 1 travels along the travel route to the determined parking space (1104).

Here, the driving system 22 includes a driving device, and the driving device may include the engine 10 or the transmission 20, but is not limited thereto.

In addition, the braking system 32 may include a braking device, and, as described above, may include the EBCM 31 (see FIG. 1) and the braking device 30 (see FIG. 1), but is not limited thereto.

In addition, the steering system 42 may include an electronic steering device 41 (see FIG. 1) and a steering device 40 (see FIG. 1), but is not limited thereto.

In addition, while the vehicle 1 is traveling, the controller 140 detects a front object located in front of the vehicle 1 and a side object located on the side of the vehicle 1 in response to processing the image data, the front detection data, or the side detection data acquired by the sensor 200, and generates a signal to at least one of the driving device, the braking device, and the steering device 40 to safely travel the travel route generated based on the detected result.

When the vehicle 1 travels on the generated travel route, the controller 140 determines whether the vehicle 1 has arrived in the parking space (1105).

Specifically, when it is determined that the vehicle 1 has arrived in the parking space, the controller 140 generates a signal to at least one of the driving device, the braking device, and the steering device 40 to perform automatic parking (1106).

However, when it is determined that the vehicle 1 has not reached the parking space, the controller 140 generates a signal to at least one of the driving device, the braking device, and the steering device 40 so that the vehicle 1 continuously travels the generated travel route.

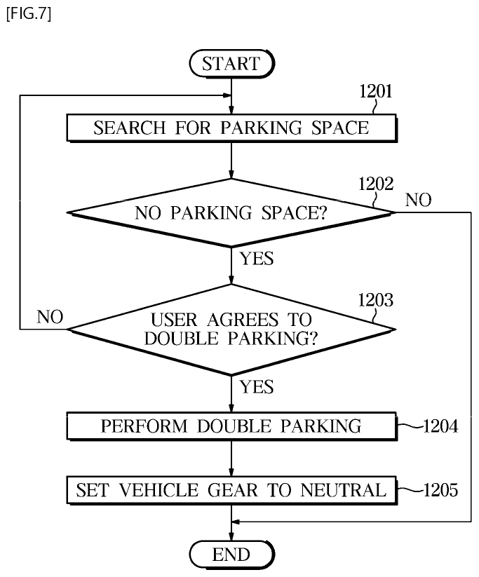

FIG. 7 is a flowchart illustrating a process of controlling the vehicle such that the controller 140 performs double parking according to an embodiment.

The controller 140 searches for a parking space existing in the building 3 based on the received map information (1201).

When searching for a parking space, the controller 140 determines whether the parking space exists in the building (1202).

Specifically, when it is determined that there is no parking space in the building, the controller 140 transmits a signal indicating whether or not to allow double parking to the user to the user terminal (1203). However, when it is determined that there is a parking space in the building 3, the controller 140 determines the parking space without transmitting a signal indicating whether or not to allow double parking to the user to the user terminal.

When the user inputs a signal agreeing to double parking to the user terminal 2, the controller 140 controls the vehicle 1 to perform double parking of the vehicle 1 (1204).

Specifically, when a user inputs a signal for consenting to double parking in the user terminal 2, the user terminal 2 transmits the signal input by the user to the controller 140, and the controller 140 generates a signal to at least one of a driving device, a braking device, or a steering device 40 so that the vehicle 1 performs double parking.

When the double parking is completed, the controller 140 controls the gear of the vehicle 1 so that the gear of the vehicle 1 is set to neutral (N) (1205).

In addition, when the double parking is completed, the controller 140 transmits the parking result related to the double parking to the user terminal 2.

FIG. 8A illustrates the display of building information on the user terminal 2 according to an embodiment.

Specifically, the controller 140 may receive building information from the building 3 or the server provided in the building 3, and transmit the received information to the user terminal 2.

In addition, the user terminal 2 may display the received information.

Referring to FIG. 8A, The building information may include the number of floors of the building, information on the underground parking lot, information on the ground parking lot, the curvature of the parking lot, or a parking fee, but is not limited thereto.

FIG. 8B is a diagram showing an indication of whether or not to consent to double parking on the user terminal 2 according to an embodiment.

As described above, when it is determined that there is no parking space, the controller 140 may transmit a signal to the user terminal 2 so that the user terminal 2 displays whether or not to consent to double parking. When the user inputs a signal consenting to dual parking in the user terminal 2, the user terminal 2 transmits a user's input signal to the controller 140 and controls the driving system 22, the braking system 32, or the steering system 42 so that the vehicle 1 performs double parking.

FIG. 8C illustrates displaying a parking result on a user terminal according to an embodiment.

Referring to FIG. 8C, The displayed parking result may include the location where the vehicle 1 is parked, the parking time, a parking fee, or whether a double parking is performed, but is not limited thereto.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored, for example, a Read Only Memory (ROM), a Random Access Memory (RAM), a magnetic tape, a magnetic disk, a flash memory, an optical data storage device, and the like.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes.

### DESCRIPTION OF SYMBOLS

1: vehicle
2: user terminal
3: building
100: driver assistance system
200: sensor
140: controller
143: communication module
22: driving system
32: braking system
42: steering system

What is claimed is:

1. A driver assistance system, the driver assistance system comprising:
a sensor installed in a vehicle and acquiring at least one of front image data, front detection data, and side detection data; and
a controller including a processor configured to process the front image data, the front detection data, and the side detection data,
wherein the controller is configured to:
receive building map information, determine whether a parking space exists from the building map information, and
generate a travel route to the parking space based on the presence or absence of the parking space, and
wherein the controller is configured to:
detect a front object located in front of the vehicle and a side object located on the side of the vehicle in response to processing the image data, the front detection data, and the side detection data, and
output a signal to at least one of a driving device, a braking device, and a steering device of the vehicle to travel the travel route based on a detected result.

2. The driver assistance system of claim 1, wherein when the vehicle reaches the parking space, the controller is configured to output a signal to at least one of an engine, a braking device, and a steering device of the vehicle to perform automatic parking.

3. The driver assistance system of claim 1, wherein the controller is configured to determine whether the parking space exists, and perform double parking based on a determined result.

4. The driver assistance system of claim 3, wherein the controller is configured to set the gear of the vehicle to neutral when it is determined that the vehicle is double-parked.

5. The driver assistance system of claim 1, wherein the controller is configured to detect a movement of another vehicle and change the travel route to avoid driving the other vehicle.

6. The driver assistance system of claim 1, wherein the controller is configured to transmit information on the travel route to a user terminal.

7. The driver assistance system of claim 2, wherein the controller is configured to transmit the result of the automatic parking to the user terminal.

8. A driver assistance method, the driver assistance method comprising:
acquiring at least one of front image data, front detection data, and side detection data;
processing the front image data, the front detection data, and the side detection data; receiving building map information,
determining whether a parking space exists from the building map information, and generating a travel route to the parking space based on the existence of the parking space; and
detecting a front object located in front of the vehicle and a side object located on the side of the vehicle in response to processing the image data, the front detection data, and the side detection data, and outputting a signal to at least one of a driving device, a braking device, or a steering device of the vehicle to travel the drive route based on a detected result.

9. The driver assistance method of claim 8, further comprising:
outputting a signal to at least one of an engine, a braking device, and a steering device of the vehicle to perform automatic parking when the vehicle reaches the parking space.

10. The driver assistance method of claim 8, further comprising: determining whether the parking space exists, and performing double parking based on the determined result.

11. The driver assistance method of claim 10, further comprising: setting a gear of the vehicle to neutral when it is determined that the vehicle is double-parked.

12. The driver assistance method of claim 8, further comprising: detecting a movement of another vehicle and changing the travel route to avoid driving the other vehicle.

13. The driver assistance method of claim 8, further comprising: transmitting information on the travel route to a user terminal.

14. The driver assistance method of claim 9, further comprising: transmitting the result of the automatic parking to a user terminal.

15. A driver assistance system, comprising:
a sensor installed in a vehicle and acquiring at least one of front image data, front detection data, and side detection data; and
a controller including a processor configured to process the front image data, the front detection data, and the side detection data,
wherein the controller is configured to:
receive building map information, determine whether a parking space exists from the building map information, and
generate a travel route to the parking space based on the presence or absence of the parking space, and
wherein the controller is configured to:
detect a front object located in front of the vehicle and a side object located on the side of the vehicle in response to processing the image data, the front detection data, and the side detection data, and
output a signal to at least one of a driving device, a braking device, and a steering device of the vehicle to travel the drive route based on a detected result.

16. The driver assistance system of claim 15, wherein when the vehicle reaches the parking space, the controller is configured to output a signal to at least one of an engine, a braking device, and a steering device of the vehicle to perform automatic parking.

17. The driver assistance system of claim 15, wherein the controller is configured to determine whether the parking space exists, and perform double parking based on the determination result.

18. The driver assistance system of claim 17, wherein the controller is configured to set the gear of the vehicle to neutral when it is determined that the vehicle is double parking.

19. The driver assistance system of claim 15, wherein the controller is configured to detect a movement of another vehicle and change the travel route to avoid driving the other vehicle.

20. The driver assistance system of claim 15, wherein the controller is configured to transmit at least one of the travel route or the automatic parking result to the user terminal.
